(19) United States
(12) Patent Application Publication
(10) Pub. No.: US 2010/0166428 A1
(43) Pub. Date: Jul. 1, 2010

(54) INFRARED APPARATUS TRANSMITTING THROUGH A WIRELESS COMMUNICATION PROTOCOL INTERFACE OF A NETWORK ADDRESSED SERVER

(76) Inventor: Jih-Shan Tang, Taichung County (TW)

Correspondence Address: APEX JURIS, PLLC, 12733 LAKE CITY WAY NORTHEAST, SEATTLE, WA, 98125, US

(21) Appl. No.: 12/347,894

(22) Filed: Dec. 31, 2008

(51) Int. Cl. H04B 10/00

(52) U.S. Cl. 398/106

(57) ABSTRACT

An infrared apparatus transmitting through a wireless communication protocol interface of a network addressed server for linking a host to the Internet to control a remote electric device includes a server and an infrared learning and memory emission unit. The server allows the host to be linked to the Internet through dial-up access and has a RS485 interface unit located and linked inside. The infrared learning and memory emission unit respectively bridges the RS485 interface unit and the electric device. Through infrared signal transmission of the infrared learning and memory emission unit the RS485 interface unit and the electric device can be linked to allow users to control operation of the electric device.

### FIELD OF THE INVENTION

The present invention relates to a server used in a surveillance system and particularly to an infrared apparatus adopted a wireless communication protocol interface of a network addressed server to perform transmission.

### BACKGROUND OF THE INVENTION

These days high-tech and safety are an increasing focus of many household appliances. Remote controllers play a greater role in these concerns. Among them the remote controller adopted infrared (IR) transmission technique has a greater advantage because of its simpler operation and lower cost.

IR is an optical transmission technology which is also constrained by optical characteristics, such as incapable of penetrating obstacles and ought to traveling in a straight line. The conventional IR techniques can be divided into direct-beam IR (DB/IR) and diffuse IR (DF/IR). The DB/IR is adopted to two communication ports facing each other without obstacles interposed between them. It is safer and less likely to be intercepted. But the communication range is smaller. In practice, the IR beam emitted from a communication port is receivable within a deviation angle of 15 degrees. On the other hand, the communication ports of DF/IR do not have face each other. As long as they are located in the same closed space a communication link can be established. But interference easily occurs and results in failure of data transmission or establishing of the communication link. All these problems, namely short communication distance and interference, beg for improvement.

### SUMMARY OF THE INVENTION

Therefore, the primary object of the present invention is to provide an infrared (IR) apparatus that adopts a wireless communication protocol interface of a network addressed server to perform transmission.

The IR apparatus according to the invention aims to connect at least one host to a network such as the Internet to enable the host to control at least one electric device at a remote site. The invention includes a server and a plurality of IR learning and memory emission units. The server allows the host to be linked to the Internet through dial-up access. The server also is linked to a RS485 interface unit inside. The IR learning and memory emission units bridge the RS485 interface unit and electric device to transmit IR signals between them. Thus operation of the electric device can be controlled by users as desired.

After the host and server are linked to the Internet, the IR learning and memory emission units serve as a medium between the RS485 interface unit and electric device to transmit the IR signals to control the electric device. Hence the users can control and regulate the electric device installed indoors.

The IR apparatus provided by the invention can provide many benefits, such as:

1. By bridging the IR learning and memory emission units between the RS485 interface unit and the electric device to transmit the IR signals, a lower power IR transmission is established and operation is simpler. Product competitiveness is enhanced.

2. Through the invention the conventional IR technique can be incorporated with a conventional surveillance system. Thus through the host users can control the electric device in the house in a remote fashion to improve humanity and safety of living condition.

The foregoing, as well as additional objects, features and advantages of the invention will be more readily apparent from the following detailed description, which proceeds with reference to the accompanying embodiments and drawings. The embodiments serve merely for illustrative purpose and are not the limitations of the invention.

### BRIEF DESCRIPTION OF THE DRAWINGS

FIG. 1 is a schematic view of an IR apparatus according to the invention.

FIG. 2 is a schematic view of another IR apparatus according to the invention.

FIG. 3 is a schematic view of a spatial configuration of an IR apparatus according to the invention.

### DETAILED DESCRIPTION OF THE PREFERRED EMBODIMENTS

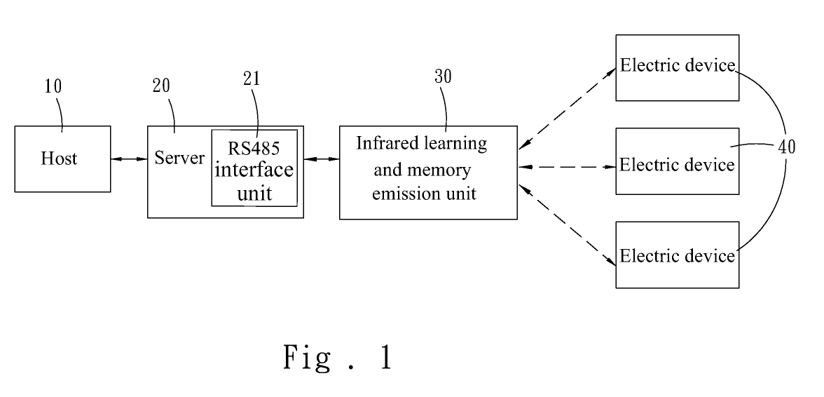

Please refer to FIG. 1, the invention aims to connect at least one host 10 to a network such as the Internet to control at least one remote electric device 40. The IR apparatus of the invention includes a server 20 and a plurality of IR learning and memory emission units 30. The server 20 allows the host 10 to be linked to the Internet through dial-up access and has a RS485 interface unit 21 connected inside. The IR learning and memory emission units 30 respectively bridge the RS485 interface unit 21 and the electric device 40 to transmit IR signals between them to control the operation of the electric device 40. The host 10 may be a computer or a mobile phone. The electric device 40 may be a lighting feature, air conditioner, audio equipment or TV set.

Hence after the host 10 and the server 20 are linked to the Internet, the IR learning and memory emission units 30 serve as a medium between the RS485 interface unit 21 and the electric device 40, and the IR signals can be transmitted to control the electric device 40. Namely the RS495 interface unit 21 transmits signals to the IR learning and memory emission units 30 which in turn send the IR signals to another IR learning and memory emission unit 30 installed on the electric device 40. Thereby operation of the electric device 40 installed indoors can be controlled by users as desired.

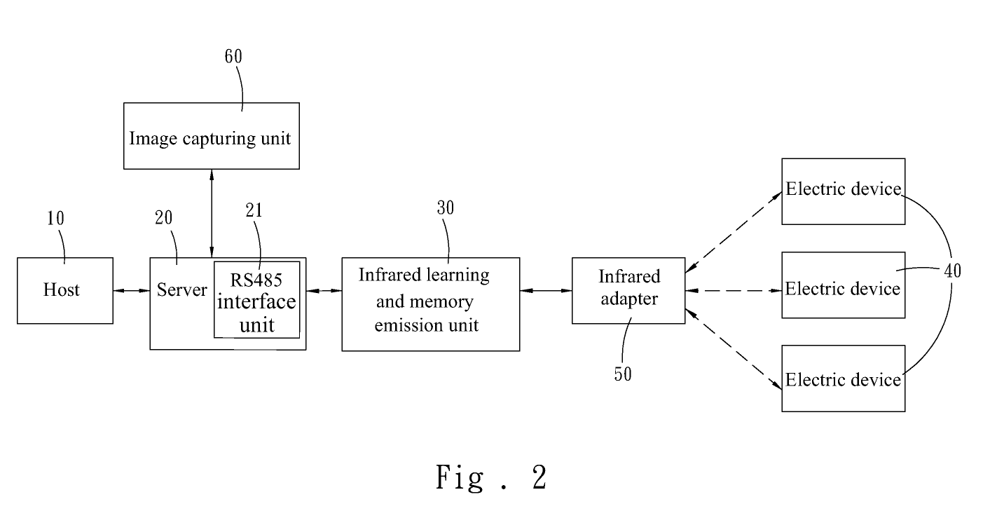

Refer to FIG. 2 for another embodiment of the invention. In the event that users are outdoors and there are obstacles indoors, such as a large furniture or wall, the server 20 may have at least one image capturing unit 60 located therein, and an IR adapter 50 is added to link the IR learning and memory emission units 30. The image capturing unit 60 is a surveillance device. The IR adapter 50 can extend the IR transmission distance and overcome obstacles of external articles. The IR adapter 50 also can be linked to multiple electric devices 40 to extend applications. Thus when an offsite user wants to control an electric device 40 in another room, the image can be seen through the image capturing unit 60; then through the host 10 and the IR learning and memory emission units 30 linking to the RS485 interface unit 21, signals can be transmitted to the IR adapter 50 and sent to another IR learning and memory emission unit 30 located in the electric device 40. Thereby the user can see the electric device 40 through the image capturing unit 60 and perform control through the host 10 by means of IR transmission technique.

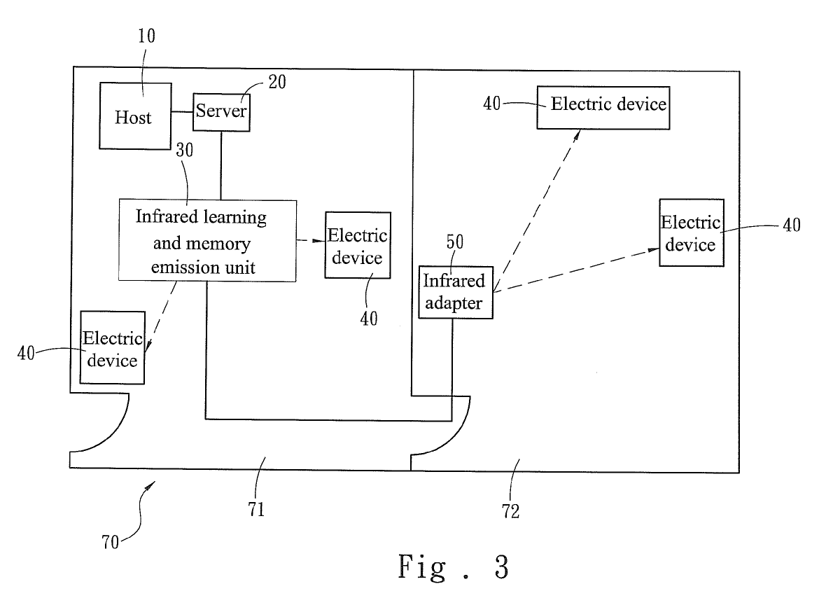

Refer to FIG. 3 for a spatial configuration of an IR apparatus according to the invention. A room 70 is divided into space A (71) and space B (72) both have an image capturing unit 60 linking to the server 20 to see indoor conditions of the space 71 and 72. As the optical characteristics of IR transmission do not allow direct control of the electric devices 40 installed in the space B (72) from the space A (71), the IR adapter 50 is provided in the space B (72) linking to the RS485 interface unit 21 and the server 20 so that through the image capturing unit 60 in the space A (71) the indoor conditions of the space B (72) can be seen on the host 10, and the electric device 40 installed in the space 72 also can be controlled as desired. Thus through proper network and wiring configurations, the electric devices 40 installed in difference spaces of the room 70 can be controlled as desired. As a result, the drawbacks occurred to the conventional IR transmission technique can be overcome. The invention not only maintains the benefits of low cost and simple operation of the IR technique, also eliminates the shortcomings of the conventional IR technique such as hindering by obstacles and short transmission distance.

The server 20 can be connected to multiple hosts 10 which in turn can be linked to the Internet through dial-up access. When a host 10 is a remote computer (not shown in the drawings) and linked to the server 20, and the image capturing unit 60 is installed in a house, the indoor conditions of the house can be seen through the image capturing unit 60, and the electric device 40 indoors can be started or stopped as desired. The electric device 40 may be a lighting fixture, audio equipment, air conditioner or power switch. Such a feature not only provides improved safety of the electric device 40 in the house, also enhances convenience. For instance, a selected number of lighting fixtures can be turned on at a selected time and at a desired brightness to give users a warm feeling upon coming home. The audio equipment or power switch of the water heater can be turned on in advance so that the users can instantly enjoy the soothing music and hot bath when arriving home.

In short, the IR apparatus of the invention adopts the low cost and simple IR transmission technique. By coupling with the server 20, RS485 interface unit 21 and IR learning and memory emission units 30, it overcomes the shortcomings of the conventional IR technique such as short IR transmission distance and hindering by obstacles. The invention also can be differentiated with other high cost techniques such as laser or Bluetooth transmission by providing improved safety and convenience at a lower cost.

What is claimed is:

1. An infrared apparatus transmitting through a wireless communication protocol interface of a network addressed server for linking at least one host to the Internet to control at least one remote electric device, comprising:
a server allowing the host to be linked to the Internet through dial-up access and having a RS485 interface unit located and linked inside; and
a plurality of infrared learning and memory emission units respectively bridging the RS485 interface unit and the electric device.

2. The infrared apparatus of claim 1, wherein the host is a computer.

3. The infrared apparatus of claim 1, wherein the host is a mobile phone.

4. The infrared apparatus of claim 1, wherein the server is connected to at least one image capturing unit.

5. The infrared apparatus of claim 4, wherein the image capturing unit is a surveillance device.

6. The infrared apparatus of claim 1, wherein the infrared learning and memory emission units are connected to an infrared adapter which is linked to a plurality of electric devices.

7. The infrared apparatus of claim 1, wherein the electric device is selectively a lighting fixture, audio equipment, an air conditioner and a television set.
